(19) United States
(12) Patent Application Publication
(10) Pub. No.: US 2013/0164620 A1
(43) Pub. Date: Jun. 27, 2013

(54) CATHODE FOR LITHIUM-SULFUR SECONDARY BATTERY CONTAINING SULFUR-INFILTRATED MESOPOROUS NANOCOMPOSITE STRUCTURE AND MESOPOROUS NANO CONDUCTIVE MATERIAL

(71) Applicants: Hee Jin Woo, Uiwang (KR); Hee Yeon Ryu, Uiwang (KR)

(72) Inventors: Hee Jin Woo, Uiwang (KR); Hee Yeon Ryu, Uiwang (KR)

(73) Assignee: HYUNDAI MOTOR COMPANY, Seoul (KR)

(21) Appl. No.: 13/426,967

(22) Filed: Mar. 22, 2012

(30) Foreign Application Priority Data
Dec. 23, 2011 (KR) 10-2011-0141782

(51) Int. Cl. H01M 4/58; H01M 4/04; B82Y 30/00

(52) U.S. Cl. 429/218.1; 427/77; 977/773; 977/948

(57) ABSTRACT

Disclosed is a cathode for a lithium-sulfur secondary battery. The cathode for the lithium-sulfur secondary battery includes a sulfur-infiltrated mesoporous nanocomposite structure and a mesoporous conductive material. The sulfur-infiltrated mesoporous nanocomposite structure includes a mesoporous conductive material with pores infiltrated with sulfur particles. The mesoporous conductive material has vacant pores and the same type of mesoporous conductive material as the sulfur-infiltrated mesoporous nanocomposite structure. Here, the sulfur-infiltrated mesoporous nanocomposite structure and the mesoporous conductive material are disposed at a volume ratio of about 1:0.1 to 0.9 and are adjacent to each other.

### CROSS-REFERENCE TO RELATED APPLICATION

This application claims under 35 U.S.C. §119(a) the benefit of Korean Patent Application No. 10-2011-0141782 filed Dec. 23, 2011, the entire contents of which are incorporated herein by reference.

### BACKGROUND

(a) Technical Field

The present invention relates to a cathode for a lithium-sulfur secondary battery containing a sulfur-infiltrated mesoporous nanocomposite structure and a mesoporous nano conductive material. More particularly, it relates to a cathode for a lithium-sulfur secondary battery, which significantly improves the coulombic efficiency and lengthen the lifespan of a battery, by synthesizing a sulfur-infiltrated mesoporous nanocomposite structure having pores infiltrated with sulfur particles and then adding the same type of mesoporous conductive material and by allowing polysulfide to move the shortest distance for an oxidation-reduction reaction during charging/discharging because sulfur particles are evenly diffused into pores of a sulfur-infiltrated mesoporous conductive material and a conductive material with vacant pores.

(b) Background Art

Secondary batteries are currently being used as large-capacity power storage batteries in, for example, electric vehicles and battery power storage systems, and high-performance small-sized energy sources of portable electronics such as mobile phones, camcorders and notebooks. Even though studies related to miniaturization of portable electronics, weight lightening of components for the purpose of long time continuous use, and low power consumption have been conducted by a number of companies, secondary batteries that can realize reduced sizing and increased capacity are still needed.

Lithium ion batteries acting as secondary batteries have a higher energy density and to larger capacity over a specific area than nickel-manganese batteries or nickel-cadmium batteries. Also, lithium ion batteries have a low self-discharging rate and an increased lifespan.

Often times in nickel cadmium rechargeable batteries a memory effect is observed that causes these types of batteries to hold a lower charge. That is, these batteries gradually lose their maximum energy capacity if they are repeatedly recharged after being only partially discharged. Thus, the battery appears to “remember” a smaller capacity than it in actuality has. Lithium batteries, on the other hand, do not show this memory effect and thus are more efficient and convenient as they allow for multiple recharges while maintaining maximum capacity.

However, lithium ion batteries for next-generation electric vehicles are limited due to low stability caused from overheating, low energy density, and low power. In order to overcome the above limitations of lithium ion batteries, studies on post lithium ion batteries such as lithium-sulfur secondary batteries and lithium-air secondary batteries are being actively conducted.

Since lithium-sulfur secondary batteries show theoretical energy density which is five times greater than a typical lithium ion battery (about 2500 Wh/kg), they are suitable as batteries for electric vehicles which require high power and high energy density. However, the self-discharging effect which occurs due to the polysulfide shuttle phenomenon may cause a shortened lifespan.

Korean Patent No. 484,642 discloses a positive active material for a lithium-sulfur battery, including a sulfur-conductive material agglomerated material in which conductive material particles such as carbon having an average particle size of about 10 nm to about 200 nm are attached on the surface of sulfur particles. The positive active material is manufactured by mixing and milling sulfur powder and conductive material powder and then drying an agglomerated composite at a temperature of about 30° C. to about 100° C. A sulfur-conductive material agglomerated material is obtained by mixing, milling, and drying of the conductive material powder. However, since the agglomerated material is obtained by attaching conductive material particles on the surface of sulfur particles instead of a composite with sulfur particles infiltrated into nano-conductive particles, the coulombic efficiency is still not good.

Also, U.S. Pat. No. 6,194,099 discloses a microporous network structure with an electrically conductive cathode having a coating layer which includes one or more fillers having better conductivity than inactive carbon nanofiber and electrically active sulfur atoms existing in an oxidation state. The coating layer also includes polysulfide and a solid composite cathode that includes inactive carbon nanofibers, in which each carbon nanofiber is three-dimensional. Although the disclosure also includes a coating concept, the performance of the coating reduced during continuous charging/discharging, leaving a room for improvement in the coulombic efficiency.

On the other hand, Korean Patent Application Publication No. 2010-136974 discloses a material including carbon and sulfur in a nanoporous matrix form with nano-porosity. A material absorbed into a portion of the nano-porosity of carbon matrix such that free volume available in the nano-porosity exists in sulfur. Although this technology is significantly advanced in that sulfur is infiltrated in the carbon porous matrix, the spatial movement of sulfur particles is not secured during charging/discharging. Accordingly, a polysulfide shuttle phenomenon occurs, and the oxidation-reduction reaction is not efficiently performed, leading to reduction of the coulombic efficiency.

In order to overcome limitations caused by the polysulfide shuttle phenomenon of a lithium-sulfur battery, technologies which apply porous carbon materials have recently been emerging. FIG. 1 is a view illustrating a sulfur-infiltrated mesoporous carbon nanocomposite synthesized by injecting sulfur into fine pores formed in a mesoporous carbon material disclosed in U.S. Patent Application Publication No. 2011/0052998. First, if a mesoporous carbon material with meso-porosity is synthesized, and then etching is performed using potassium hydroxide (KOH), micro-porosity is formed on the inner wall of the mesoporous carbon material. Thereafter, a solution dissolved with carbon disulfide (CS2) and the mesoporous carbon material is mixed, and the mixture is heat-treated in a nitrogen atmosphere of about 140° C. and is infiltrated with sulfur. When charging/discharging is performed using an electrode manufactured by such a method, upon discharging, sulfur of micro-pores receive electrons to be dissolved into a polysulfide [Sx2-] state by a reduction reaction. Dissolved polysulfide is not diffused into the electrolyte, but confined in the meso-porosity to react with lithium ions.

Such a technology has limitations in that the quantity of sulfur capable of being infiltrated into the micro-porosity is limited and polysulfide diffused into the meso-porosity during discharging may be rediffused into vacant micro-porosity by a capillary force due to a size difference between the meso-porosity and the micro-porosity. The rediffused polysulfide reacts with lithium ions in the micro-porosity to form lithium polysulfide and block a path by which polysulfide can intrude from the meso-porosity to the micro-porosity. As the frequency of charging/discharging increases, however, the lifespan of the battery also decreases. Also, since a distance between the micro-porosity and the meso-porosity is not uniform, the coulombic efficiency may be still reduced.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a cathode for a lithium-sulfur secondary battery containing a sulfur-infiltrated mesoporous nanocomposite structure and a mesoporous nano conductive material, which reduces the self-discharging effect and lengthens the lifespan of the lithium-sulfur secondary battery by inhibiting the polysulfide shuttle phenomenon by infiltrating sulfur into pores of a mesoporous conductive material and adding the same type of mesoporous conductive material with pores.

The present invention also provides a cathode for a lithium-sulfur secondary battery, which is excellent in regards to coulombic efficiency and has a lengthened lifespan due to minimization of the self-discharging effect.

The present invention also provides a cathode for a lithium-sulfur secondary battery with a new structure in which a sulfur-infiltrated mesoporous conductive material and a mesoporous conductive material with pores are mixed.

In one aspect, the present invention provides a cathode for a lithium-sulfur secondary battery, having: a sulfur-infiltrated mesoporous nanocomposite structure including a mesoporous conductive material with pores infiltrated with sulfur particles; and a mesoporous conductive material with vacant pores and the same type of mesoporous conductive material of the sulfur-infiltrated mesoporous nanocomposite structure, wherein the sulfur-infiltrated mesoporous nanocomposite structure and the mesoporous conductive material are disposed at a volume ratio of about 1:0.1 to 0.9 and are adjacent to each other.

Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein: FIG. 1 is a view illustrating a sulfur-infiltrated mesoporous carbon nanocomposite synthesized by injecting sulfur into fine pores formed in a mesoporous carbon material disclosed in U.S. Patent Application Publication No. 2011/0052998;

FIG. 2 is a view illustrating a method for manufacturing a cathode for a lithium-sulfur secondary battery containing a sulfur-infiltrated mesoporous nanocomposite and a mesoporous nano conductive material;

FIG. 3 is a view illustrating an operation mechanism during charging/discharging in a typical lithium-sulfur secondary battery;

FIG. 4 is a view illustrating a discharging mechanism shown during discharging of a cathode for a lithium-sulfur secondary battery according to an exemplary embodiment of the present invention;

FIG. 5 is a view illustrating a charging mechanism shown during charging of a cathode for a lithium-sulfur secondary battery according to an exemplary embodiment of the present invention;

FIG. 6 is a view illustrating a charging/discharging mechanism shown during to repetition of charging/discharging of a cathode for a lithium-sulfur secondary battery according to an exemplary embodiment of the present invention;

FIG. 7 is a view illustrating a phenomenon shown during initial charging/discharging when a cathode for a lithium-sulfur secondary battery according to an exemplary embodiment of the present invention is applied to a secondary battery;

FIG. 8 is a view illustrating a phenomenon shown during repetition of charging/discharging when a cathode for a lithium-sulfur secondary battery according to an exemplary embodiment of the present invention is applied to a secondary battery; and

FIG. 9 is a graph illustrating a comparison of measurement results of lifespan increase according to variation of discharging capacity of a battery in a test example according to an exemplary embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The above and other features of the invention are discussed infra.

Hereinafter, exemplary embodiment of the present invention will be described in detail with reference to the accompanying drawings.

The present invention is embodied within a cathode for a lithium-sulfur secondary battery that contains a sulfur mesoporous nanocomposite with sulfur particles infiltrated in a mesoporous conductive material having pores and the same type of conductive material with vacant pores. According to an embodiment of the present invention, since a nanocomposite that is a mesoporous conductive material containing sulfur and the same type of mesoporous conductive material which does not contain sulfur coexist, the spatial movement of sulfur particles can be substantially secured during charging/discharging.

The mesoporous conductive material may include powder whose average particle size ranges from about 10 nm to about 100 μm and whose porosity ranges from about 10% to about 90%. The average particle size of the sulfur particles may range from about 1 nm to about 50 μm.

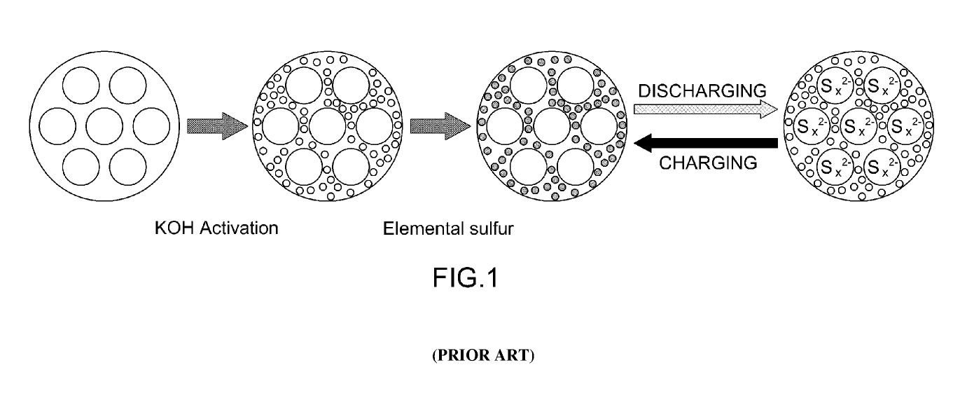

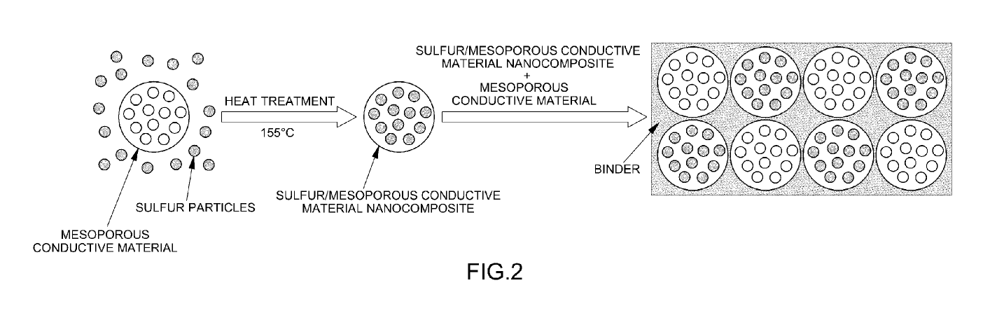

FIG. 2 illustrates a method for manufacturing a cathode for a secondary battery according to an exemplary embodiment of the present invention. More specifically, the method includes mixing the mesoporous conductive material powder with pores and sulfur particle powder at a weight ratio of about 1:0.1 to 0.9; performing heat treatment while pressurizing the mixed powder at a temperature of about 120° C. to about 180° C. for about 5 hours to about 24 hours; slowly cooling the mixed powder to manufacture sulfur mesoporous conductive material nanocomposite powder; mixing the sulfur mesoporous conductive material nanocomposite powder, the mesoporous conductive material power with vacant pores, a binder, and a solvent to manufacture a slurry; and coating the slurry on an aluminum foil and then drying the slurry at a temperature of about 60° C. to 100° C. for about 2 hours to about 24 hours.

In the above process for manufacturing the cathode, the mixing of the mesoporous conductive material powder and the sulfur particle power may be performed at a weight ratio of about 1:0.1 to 0.9. In this case, if the quantity of the sulfur particle powder is too small, sulfur particles may not be sufficiently infiltrated into the pores of the mesoporous conductive material. On the other hand, if the quantity of the sulfur particle powder is too great, the electrolyte movement path may be interrupted or the structure of the mesoporous conductive material may be destructed.

In the performing of heat treatment while pressurizing the mixed powder at a temperature of about 120° C. to about 180° C. for about 5 hours to about 24 hours, heating and pressurizing may be performed to inject sulfur particles into the pores of the mesoporous conductive material. In this case, the sulfur particles may infiltrate into the pores of the mesoporous conductive material via a capillary force acting toward the inside of the pores of the mesoporous conductive material at a temperature of about 140° C. to about 160° C. at which the sulfur particles show the best viscosity beyond a melting point (i.e., about 115° C.) of the sulfur particles.

During slow cooling of the mixed powder to manufacture sulfur mesoporous conductive material nanocomposite powder, the mixed powder may be slowly cooled so that infiltrated sulfur can be crystallized. In this case, the cooling temperature may be maintained within a temperature range in which sulfur can be maintained at the solid state. Thus, it is preferable that the cooling temperature be kept at a room temperature of, e.g., 18° C.

All of the above manufacturing processes may be performed in an atmosphere inert gas such as nitrogen and argon.

The sulfur mesoporous conductive material nanocomposite power synthesized by the above process may be mixed with mesoporous conductive material powder with vacant pore and binder. The binder may be mixed at a weight of about 5% to about 20% to manufacture slurry.

The slurry may be coated on an aluminum foil, and then the solvent may be evaporated in the drying process, at a temperature of about 60° C. to about 100° C. for about 2 hours to about 24 hours.

After the above process, a cathode for a lithium-sulfur secondary battery in which the sulfur mesoporous nanocomposite with sulfur particles infiltrated in pore of mesoporous conductive material with pore and the same type of mesoporous conductive material with vacant pores are mixed with and disposed adjacent to each other may be manufactured.

Thus, lithium-sulfur secondary batteries including a cathode according to an exemplary embodiment of the present invention and vehicle batteries including the lithium-sulfur secondary batteries may be provided. Such secondary batteries and vehicle batteries may be manufactured by applying the cathode for the secondary battery via any conventional method.

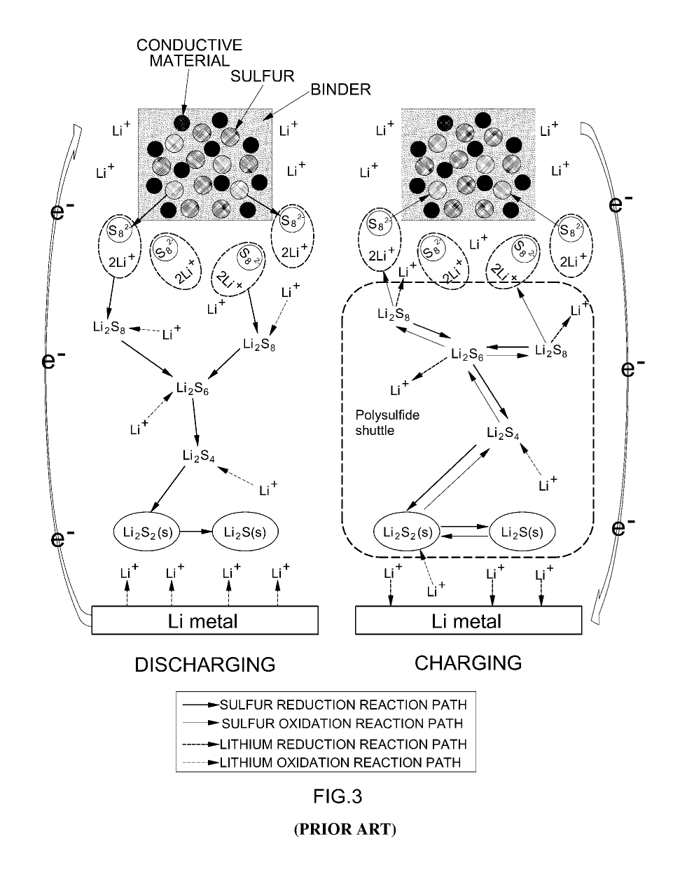

The charging/discharging mechanism of a typical lithium-sulfur secondary battery is shown in FIG. 3. Theoretically, electrons from a lithium anode during discharging may be combined with sulfur particles adjacent to the surface of the conductive material to be reduced into S82- and dissolved into electrolyte. S82- may be combined with lithium ions to form long-chain polysulfide (Li2S8) that are dissolved in electrolyte. Li2S8 may be finally precipitated on the surface of the lithium anode in a form of short-chain polysulfide (Li2S2/Li2S) through continuous reduction reaction with Li ions. During charging, the oxidation reaction may occur to return to S82- through a reverse process, and S82- may lose electrons on the surface of the conductive material to be precipitated as sulfur particles. As shown in FIG. 3, however, Li2S8 may be again reduced to Li2S2/Li2S due to a polysulfide shuttle phenomenon during the oxidation reaction from Li2S2/Li2S to Li2S8. This shuttle phenomenon may generate a driving force due to the concentration gradient of polysulfide, and thus prevent an overvoltage from occurring in the lithium-sulfur battery. However, since self-discharging continuously occurs even during charging, the battery lifespan is effectively reduced, and the efficiency of active material mass may also be reduced during charging. Accordingly, the coulombic efficiency during charging/discharging is often reduced in a typical anode due to the mechanism shown in FIG. 1.

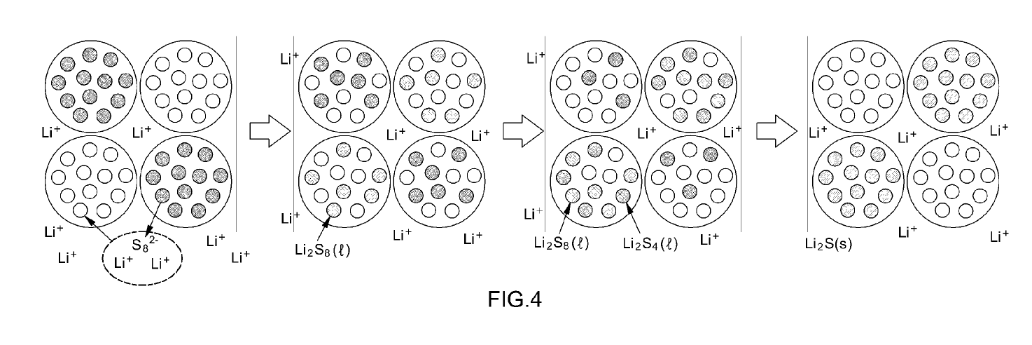

However, during discharging of the anode for the lithium-sulfur secondary battery as shown in FIG. 4, sulfur (S8) may receive electrons from the mesoporous conductive materials. When polysulfide is dissolved into the outside of the mesoporous conductive material, the to polysulfide is diffused into the pores of an adjacent mesoporous conductive material with vacant pores by a capillary force due to the concentration gradient of the polysulfide. Thereafter, the reduction reaction with lithium ions may continuously occur, thereby causing deposition of Li2S(s) inside the pores.

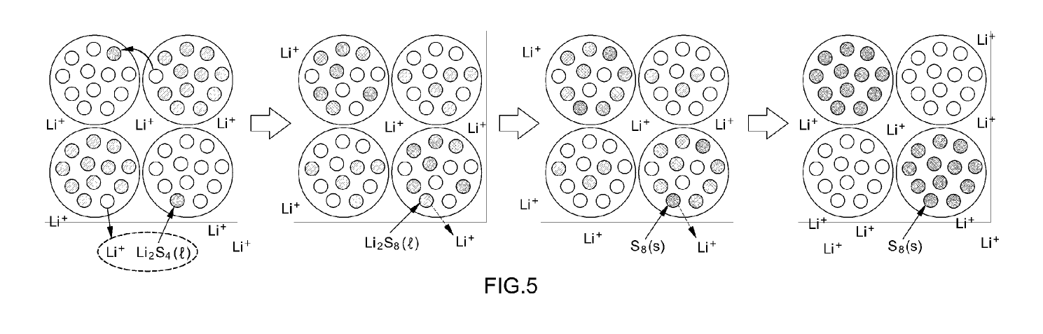

During charging as shown in FIG. 5, the mesoporous conductive material infiltrated with Li2S(s) loses electrons. When polysulfide is dissolved into the outside of the mesoporous conductive material, the polysulfide is diffused into the pores of an adjacent mesoporous conductive material with vacant pores by a capillary force due to the concentration gradient of the polysulfide. Thereafter, the oxidation reaction with lithium ions may continuously occur, thereby causing deposition of sulfur (S8) inside the pores.

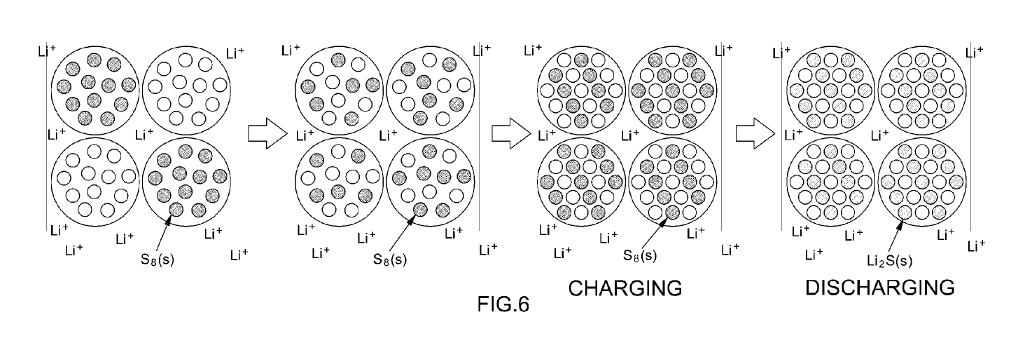

Accordingly, in the cathode structure of the present invention as shown in FIG. 6, once charging has completed, sulfur is finally deposited over a uniform interval over the whole region of the mesoporous conductive material inside the cathode due to a spontaneous reaction (second law of thermodynamics) in which entropy is lowered. Also, once discharging is completed, Li2S(s) may be deposited over a uniform interval. Accordingly, since the polysulfide shuttle phenomenon does not occur, desired coulombic efficiency may be shown.

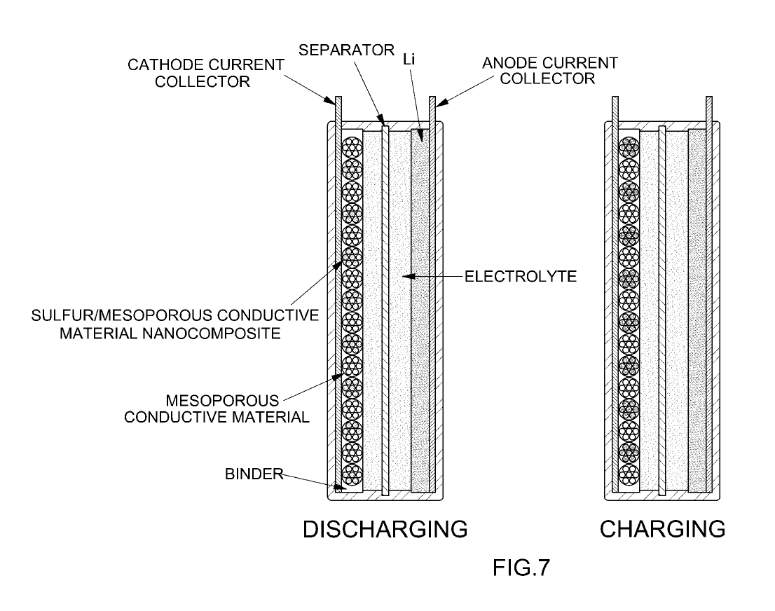

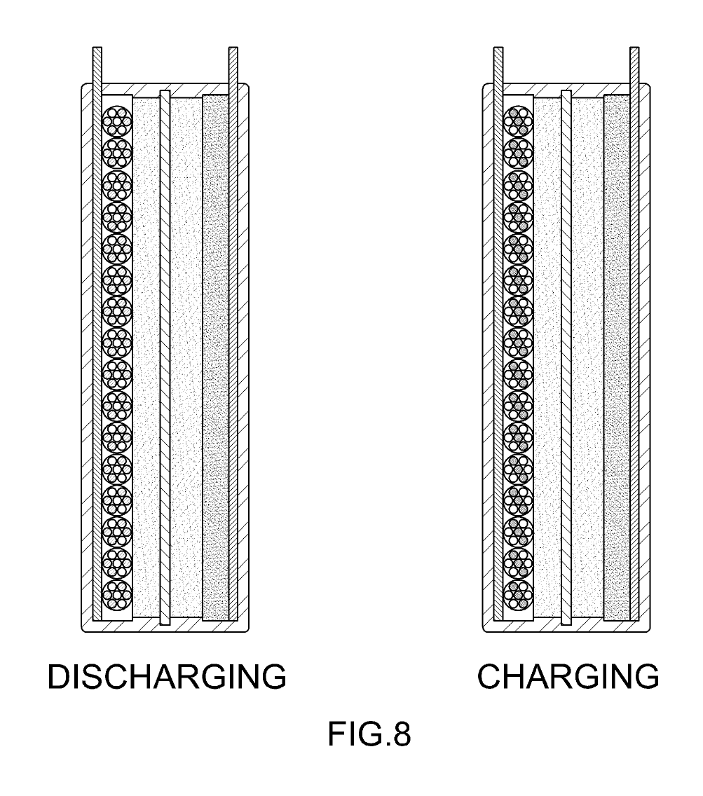

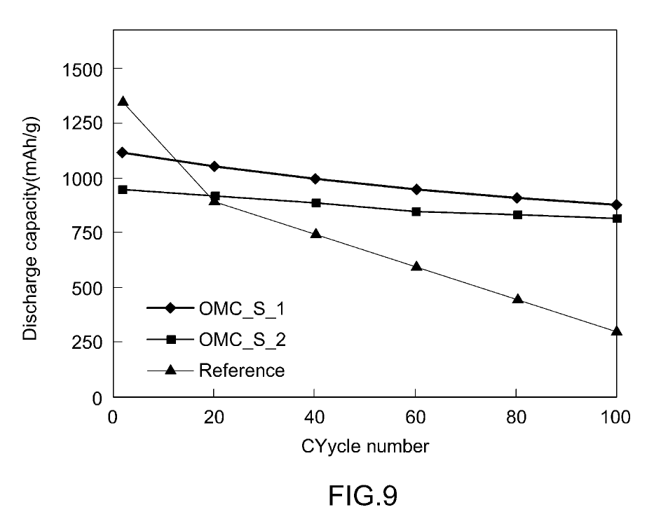

When the anode for the lithium-sulfur secondary battery according to the embodiment of the present invention is applied to batteries, at initial charging/discharging as shown in FIG. 7, the oxidation-reduction reaction of sulfur between the mesoporous conductive material infiltrated with sulfur and the vacant mesoporous conductive material may be maintained. Furthermore, during the repetition of charging/discharging as shown in FIG. 8, the oxidation-reduction reaction of sulfur may occur while maintaining a uniform interval inside the mesoporous conductive material. This shows that the cathode of the present invention is effective in inhibiting the polysulfide shuttle phenomenon.

Advantageously, when the cathode according to the exemplary embodiment of the present invention is applied to lithium-sulfur secondary batteries,

(1) it can supply a stable electrochemical reactive region as a high-strength nanostructure and provide a larger specific surface area between the conductive material and the lithium polysulfide;

(2) it can form a three-dimensional network structure with pores to inhibit lithium polysulfide from diffusing into the outside;

(3) the lithium polysulfide is not diffused into electrolyte thus preventing the polysulfide shuttle phenomenon, and the self-discharging effect can be prevented during charging, thereby lengthening the lifespan of batteries;

(4) the use of the same type of mesoporous conductive material minimizes polarization, and thus fading shown in the flat band voltage during discharging can be reduced to be effective in developing batteries with higher energy density; and

(5) since stability is achieved during charging/discharging, sulfur particles are evenly diffused into the pores of the mesoporous conductive material, thereby increasing the coulombic efficiency due to shortening of the movement distance of the polysulfide compared to a typical technology.

Hereinafter, an exemplary embodiment of the present invention will be described in detail, but the present invention is not limited thereto.

### EXPERIMENAL EXAMPLES

1 g mesoporous conductive material powder having 70% porosity and 1 g sulfur particle powder having 4 μm average particle size were evenly mixed, and then the mixture was heat-treated while being pressurized at a temperature of about 170° C. for about 10 hours to infiltrate sulfur particles into pores of the mesoporous conductive material. After the heat treatment, the mixture was slowly cooled so that the infiltrated sulfur could be crystallized. The above process was performed in an argon atmosphere. Thereafter, it was confirmed that sulfur-infiltrated mesoporous conductive material nanocomposite powder was manufactured. 2 g sulfur-infiltrated mesoporous conductive material nanocomposite powder, the same type of 0.5 g mesoporous conductive material powder with vacant pores, 0.5 g(ml) PVdF_co_HFP as binder, and NMP solvent were mixed to manufacture a slurry. The slurry was coated on an aluminum foil in a thickness of about 150 μm, and then was dried at a temperature of about 80° C. for about 2 hours to evaporate the solvent. In addition, two kinds of electrodes were manufactured by changing the composition ratio of sulfur, conductive material, and binder for comparative analysis according to the weight ratio of sulfur in the electrode.

### TEST EXAMPLE

When the two kinds of electrodes (OMC) exemplified in the experimental example above and the reference, U.S. Patent Application Publication No. 2011/0052998 were compared in cyclic characteristics, the exemplary embodiment of the present invention showed an increased lifespan in comparison with U.S. Patent Application Publication No. 2011/0052998. Although the compared electrode (i.e., U.S. Patent Application Publication No. 2011/0052998) showed higher discharging capacity in terms of initial capacity, the reduction of its capacity increased according to increase of cycles. On the other hand, the electrode according to the exemplary embodiment showed the reduction of its capacity decreased according to increase of cycles compared to the compared electrode. Thus, when an electrode was manufactured using the sulfur-infiltrated mesoporous conductive material and the same type of mesoporous conductive material with vacant pores, the lifespan of the electrode increased, and the polysulfide shuttle phenomenon was inhibited.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A cathode for a lithium-sulfur secondary battery, comprising:
a sulfur-infiltrated mesoporous nanocomposite structure comprising a mesoporous conductive material with pores infiltrated with sulfur particles; and
a mesoporous conductive material with vacant pores and the same type of mesoporous conductive material as the sulfur-infiltrated mesoporous nanocomposite structure,
wherein the sulfur-infiltrated mesoporous nanocomposite structure and the mesoporous conductive material are disposed at a volume ratio of about 1:0.1 to 0.9 and are adjacent to each other.

2. The cathode of claim 1, wherein the mesoporous conductive material is powder having an average particle size of about 10 nm to about 100 μm and a porosity of about 10% to about 90%, and the sulfur particles have an average particle size of about 1 nm to about 50 μm.

3. A method for manufacturing a cathode for a lithium-sulfur secondary battery comprising a sulfur-infiltrated mesoporous nanocomposite structure and a mesoporous conductive material, the method comprising:
mixing mesoporous conductive material powder with pores and sulfur particle powder at a weight ratio of about 1:0.1 to 0.9;
performing heat treatment while pressurizing the mixed powder at a temperature of about 120° C. to about 180° C. for about 5 hours to about 24 hours;
slowly cooling the mixed powder to manufacture sulfur-infiltrated mesoporous conductive material nanocomposite structure powder;
mixing the sulfur-infiltrated mesoporous conductive material nanocomposite structure powder, mesoporous conductive material powder with vacant pores, binder, and solvent to manufacture a slurry; and
coating the slurry on an aluminum foil and then drying the slurry at a temperature of about 60° C. to about 100° C. for about 2 hours to about 24 hours.

4. The method of claim 3, wherein the mesoporous conductive material powder has an average particle size of about 10 nm to about 100 μm and a porosity of about 30% to about 90%, and the sulfur particle powder has an average particle size of about 1 nm to about 50 μm.

5. The method of claim 3, wherein the binder is included in the mixture of the sulfur-infiltrated mesoporous conductive material nanocomposite structure powder, the mesoporous conductive material powder with vacant pores and the binder has a weight percentage of about 5% to about 20%.

6. A lithium-sulfur secondary battery comprising a cathode for a lithium-sulfur secondary battery comprising the sulfur-infiltrated mesoporous nanocomposite structure and the mesoporous nano conductive material wherein,
the sulfur-infiltrated mesoporous nanocomposite structure comprises a mesoporous conductive material with pores infiltrated with sulfur particles; and
the mesoporous conductive material with vacant pores and the same type of mesoporous conductive material as the sulfur-infiltrated mesoporous nanocomposite structure, the sulfur-infiltrated mesoporous nanocomposite structure and the mesoporous conductive material disposed at a volume ratio of about 1:0.1 to 0.9 and adjacent to each other.

7. A battery for a vehicle, comprising the lithium-sulfur secondary battery according to claim 6.
